(19) United States
(12) Patent Application Publication
(10) Pub. No.: US 2010/0153164 A1
(43) Pub. Date: Jun. 17, 2010

(54) BUSINESS MODELING AND ALGORITHMS FOR RESOLVING BUSINESS DAYS AND HOURS ON A CALENDAR

(75) Inventors: Atul Ravindra DAHERKAR, Cedar Park, TX (US); Manoj KHANGAONKAR, Pleasanton, CA (US); Chidanandan THEYANCHERI, Pleasanton, CA (US); Kai Mike ZHANG, Lake Oswego, OR (US)

Correspondence Address: Locke Lord Bissell & Liddell LLP;Attn: IP Docketing, Three World Financial Center, New York, NY, 10281-2101, US

(73) Assignee: INTERNATIONAL BUSINESS MACHINES CORPORATION, Armonk, NY (US)

(21) Appl. No.: 12/332,747

(22) Filed: Dec. 11, 2008

(51) Int. Cl. G06Q 10/00

(52) U.S. Cl. 705/9

(57) ABSTRACT

A system and method for business calendar event modeling comprises receiving a plurality of events from a computerized calendar user wherein each event is classified as an OnTime, OffTime or OtherTime event. Wherein, an OnTime event is defined as a calendar period where the calendar user is available, an OffTime event is defined as a calendar period where the calendar user is unavailable; and an OtherTime event is defined as a calendar period unrelated to the calendar user's availability. Then, calculating the calendar user's net OnTime, wherein net OnTime is a sum of periods of a day wherein an OnTime event period does not overlap with an OffTime event period. Also, calculating user available days wherein a user available day is a day having net OnTime. Calculating the number of user available days, hours and minutes before an event. And, finally alerting a user to an event at a predetermined number of days, hours or minutes before the event; or escalating an incomplete event at a predetermined number of days, hours or minutes after the event.

### FIELD

This disclosure is directed to a system and method for calendar event modeling and algorithms for resolving business days and hours on a computerized calendar. In particular, this disclosure is directed to a method for determining the availability of predefined business days.

### BACKGROUND

Most present day businesses expect their events to begin at a certain designated business time. For example, a Human Task process would like to automatically escalate an event if it is not processed within, say, “2 business days and 3 hours.” Current computerized calendar applications, such as Lotus Notes, Outlook and Mozilla/Google calendars are not able to effectively calculate business days. There are two reasons: (1) They cannot distinguish calendar entries/events that define available business days and hours from events that define available time; and (2) there are no effective algorithms for resolving the business days.

Most computerized calendar applications, such as the ones mentioned above, are iCalendar standard compliant. The foregoing is an extension on the iCalendar model and provides algorithms for solving the above problems. (iCalendar reference:

http://www.ietf.org/rfc/rfc2445.txt).

For the foregoing reasons, there is a need for an improved method for determining the availability of predefined business days for efficient business meeting and task handling.

### SUMMARY

This disclosure satisfies these needs including by providing a system and method for establishing a calendar of availability for a company's employees. This allows for the efficient process of scheduling meetings which will not conflict with any previous commitments, as well as assigning tasks to individuals with time to work efficiently to complete the tasks promptly.

In accordance with at least one embodiment, a method for business calendar event modeling is provided. This method for event modeling comprises receiving a plurality of events from a calendar user wherein each event is classified as an OnTime, OffTime or OtherTime event. Wherein, an OnTime event is defined as a calendar period where the calendar user is available, an OffTime event is defined as a calendar period where the calendar user is unavailable; and an OtherTime event is defined as a calendar period unrelated to the calendar user's availability. Then, calculating the calendar user's net OnTime, wherein net OnTime is a sum of periods of a day wherein an OnTime event period does not overlap with an OffTime event period. Also, calculating user available days wherein a user available day is a day having net OnTime. Calculating the number of user available days, hours and minutes before an event. And, finally alerting a user to an event at a predetermined number of days, hours or minutes before the event; or escalating an incomplete event at a predetermined number of days, hours or minutes after the event.

A principal objective of this invention is to extend the iCalendar model to allow calendar events to be classified as one of three types. OnTime, OffTime and OtherTime.

OnTime is defined as available business time, such as daytime, nighttime and weekend time. OffTime is defined as unavailable business time, such as holidays, vacations, appointments or meetings. OtherTime is defined as calendar events that have no contribution to availability, such as reminders, non-blocking appointments/meetings or any other transparent event. Such events are ignored in the target time calculation.

Additionally, business days are defined as a calendar day that contains net OnTime (i.e., a day on which OffTimes do not consume all OnTimes). Net OnTime is defined as the ports of OnTime slots that are not covered by the OffTime slots. Delta or duration is nbusinessDays hhours mminutes and sseconds, therefore, a business event will be triggered by nbusiness Days hhours mminutes and sseconds.

### BRIEF DESCRIPTION OF DRAWINGS

FIG. 1 illustrates a typical calendar instance.

FIG. 2 illustrates an algorithm for finding net OnTime

FIG. 3 illustrates a calendar day that contains net OnTime as a business day.

FIG. 4 illustrates a high level algorithm for calculating Delta=n businessDays h hours m minutes and s seconds.

FIG. 5 illustrates the alerting feature.

### DETAILED DESCRIPTION

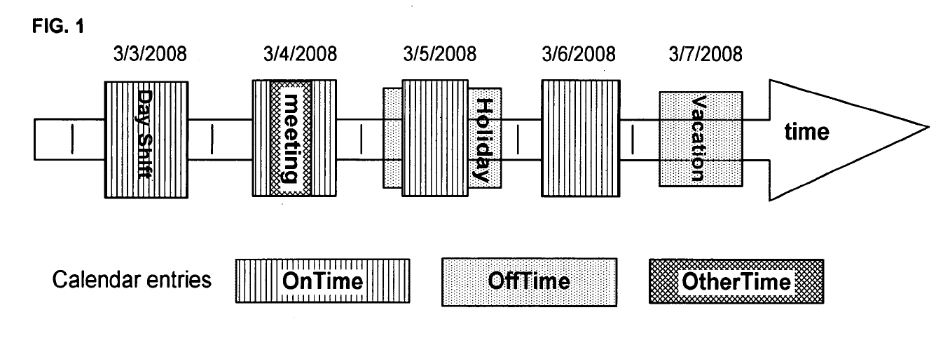

In the following description of the various examples, reference is made to the accompanying drawings that are illustrations of various embodiments in which the method may be practiced. It is to be understood, however, that those skilled in the art may develop other structural and functional modifications without departing from the scope of the instant disclosure. FIG. 1 illustrates a typical calendar instance demonstrating OnTime in the single line shaded region, OffTime in the dotted region and OtherTime in the crosshatched region. OnTime is defined as the time of availability to schedule a meeting or assign a task to be completed.

In a business or company setting, quite often there is a need to request an employee's availability or inquire as to an employee's ability to take on certain tasks. Additionally, there are instances where a user invites individual's to events or meetings via that company's calendar program, i.e., Microsoft Outlook, Lotus Notes, Google Calendar, etc. Many times these requests are answered yes or no, depending on that individual's prior commitments. This disclosure provides a method for limiting potential conflicts by providing such information to the calendar user, employee's availability or lack thereof.

The typical calendar instance illustrated in FIG. 1 provides examples of OnTime. According to FIG. 1 OnTime can include a Day Shift, time surrounding a holiday, or any available time for that specific calendar. OffTime can consist of holiday and vacation time and OtherTime consists of certain conflicts taking place during typical OnTime instances, such as a meeting, or conference.

A person's availability is crucial in terms of coordinating meetings and tasks. When trying to coordinate, it is necessary to be aware of an individual's schedule and specifically their “OnTime.” This OnTime includes days where there is nothing previously scheduled. It also includes nights and weekends which do not conflict with anything previously scheduled or holidays or vacations.

Similarly, when coordinating business meetings or tasks it is equally necessary to identify a person's “OffTime.” If a company is trying to schedule a meeting of all staff members, or a section of staff members such as the Northeast region, it is imperative to account for OffTime such as certain pre-designated holidays or vacation time. Therefore, as depicted in FIG. 1, a typical calendar instance will also include a person's holiday schedule, vacation time as well as previously scheduled meetings or appointments.

Finally, it is also important to include information with respect to “OtherTime” designated on an individual's calendar. Just as it is important to have information as it relates to an individual's OnTime and OffTime when scheduling meetings and tasks, it is important to keep track of that individual's OtherTime.

OtherTime includes calendar events that actually do not have contributions to availability, such as reminders or non-blocking appointments. Since these allotments of time do not contribute to availability, they can be ignored in the target time calculation.

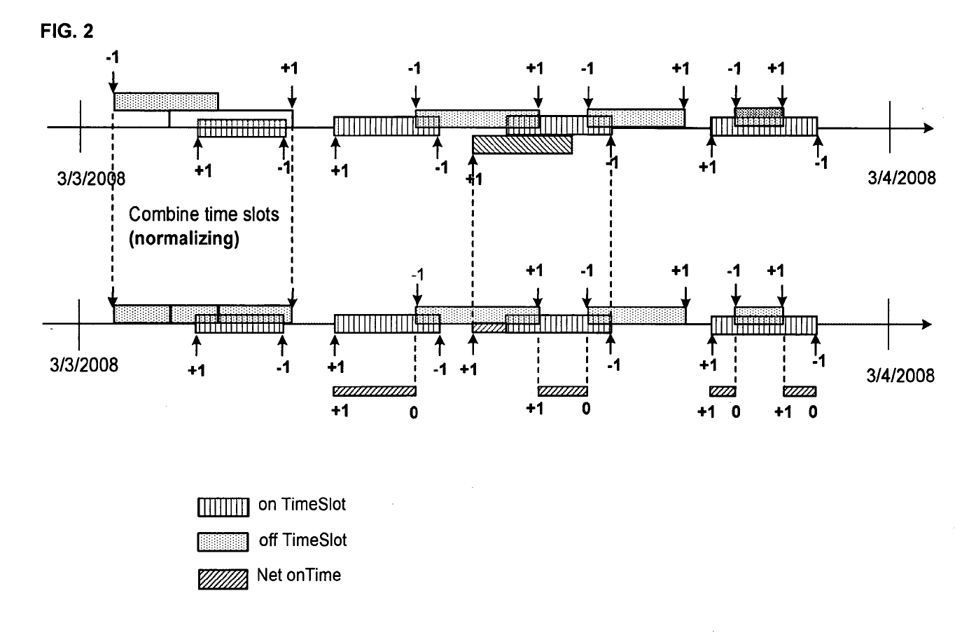

FIG. 2 illustrates the algorithm for finding net OnTime. As can be seen in FIG. 2, time slots are combined to normalize OnTimes and OffTimes respectively on the given day. OnTime and OffTime should be understood as each was described above, respectively. This is performed by associating (+1) to the start of each time slot and (−1) to the end of it.

The start of each time is the first point in time which the individual is available, therefore it is designated as (+1). However, in instances where there are OffTimes in the schedule, i.e., the individual has a meeting, the beginning of that meeting is designated as (−1).

When the individual's OnTime or available time comes to an end, the time at which this occurs is designated as (−1). Contrary, when an individual's OffTime comes to an end, it is designated as (+1).

The net OnTime is determined by combining the (+1)'s and (−1)'s, which allows the calendar user, or scheduler, to schedule meetings or tasks.

For example, if an individual is available on Monday from 9:00 a.m. to 3:00 p.m., with a meeting from 3:00 p.m. to 5:00 p.m., and then available from 5:00 p.m. to 8:00 p.m. 9:00 a.m. is designated (+1), 3:00 p.m. is designated (−1)(−1), 5:00 p.m. is designated (+1) and 8:00 p.m. is designated (−1). This gives a net available time of 9 hours, with 2 hours of unavailable time.

A more complex example is when a person is available from 9:00 a.m. to 12:00 p.m. and 3:00 p.m. to 5:00 p.m., unavailable from 11:45 a.m. to 3:15 p.m. and 4:45 p.m. to 6:00 p.m. 9:00 a.m. is associated with (+1), 12:00 p.m. is associated with a (−1), 11:45 a.m. is associated with a (−1), 3:15 p.m. is associated with a (+1), 3:00 p.m. is associated with a (+1), 5:00 p.m. is associated with a (−1), 4:45 p.m. is associated with a (−1) and 6:00 p.m. is associated with a (+1).

### That is,

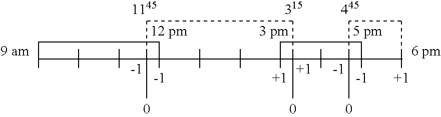

Once again, the net OnTime is determined by normalizing the times and finding the zeros.

Next, the algorithm sorts start and end times of all time slots together. Then it finds +1 and 0 pairs which are normalized time slots. This allows the calendar to determine where there is an overlap of time slots.

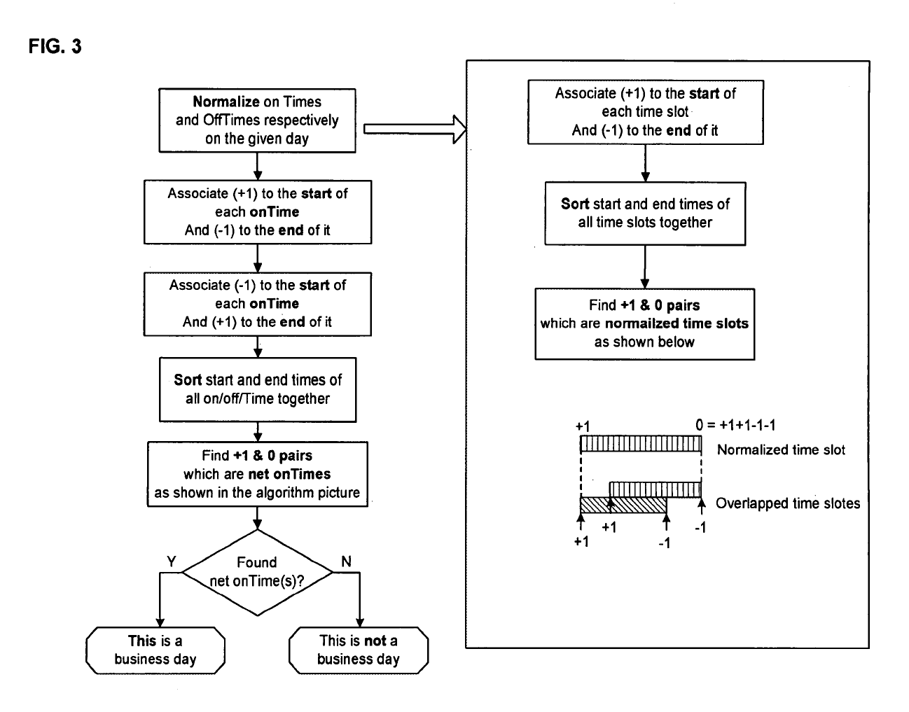

FIG. 3 is a flow chart illustrating a calendar day that contains net OnTime as a business day. First the algorithm normalizes OnTime and OffTimes respectively on the given day. See FIG. 2 for algorithm. Associate (+1) to the start of each OnTime and (−1) to the end of it. Then associate (−1) to the start of each OffTime and (+1) to the end of the OffTime. Sort start and end times of all On/OffTime together. Find +1 and 0 pairs which are net OnTimes. If Net OnTime is calculated, the result is a business day. If not, it is not a business day.

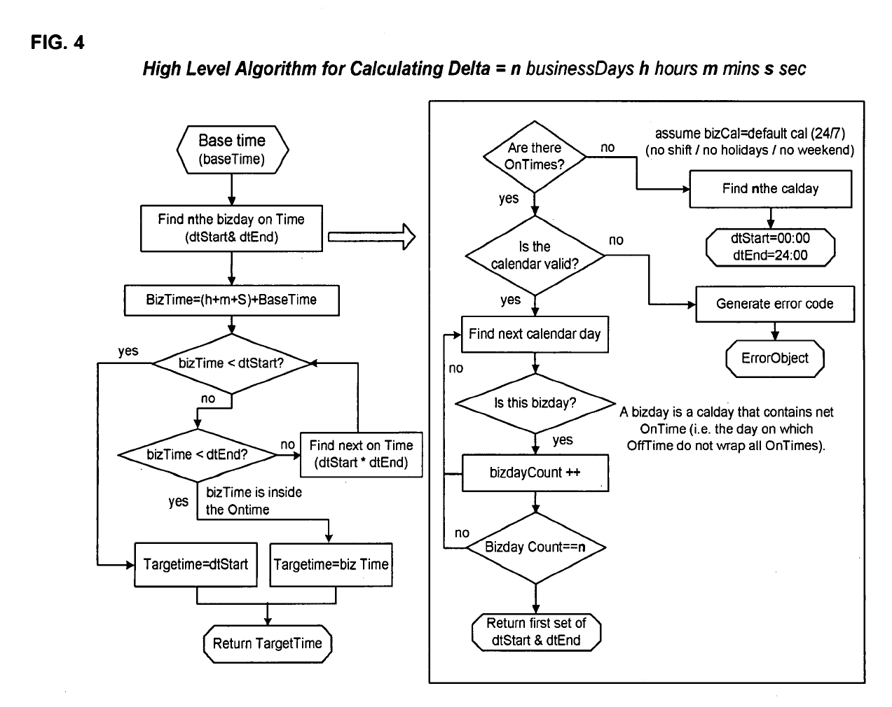

FIG. 4 provides a flow chart of a high level algorithm for calculating Delta=n business days h hours m minutes and s seconds. Begin with base time and find nth business day OnTime. In this flow chart “bizTime” is the equivalent of (h+m+s)+baseTime. If the bizTime is less than the dtStart, target time is dtStart. If, however, the bizTime is greater than dtStart, it is then checked to see if it is less than dtEnd. If it is less than dtEnd, biztime is inside the OnTime and therefore the target time equals the bizTime. If bizTime is not less than dtEnd, the algorithm then finds the next OnTime (dtStart and dtEnd) to recalculate and once again locate available OnTime on the particular calendar day.

Finding nth bizday OnTime (dtStart & dtEnd) is also illustrated in FIG. 4. The first step is determining whether there are OnTimes. The algorithm assumes bizCal=default calendar of (24/7) availability, where there is no shift, no holiday and no weekend blocked out. If there are no OnTimes, the algorithm finds nth calday, with the dtStart of 00:00 and a dtEnd of 24:00. If there are OnTimes available and the calendar is valid, it then goes to the next calendar day to determine if it is a bizday. A bizday is a calday that contains net OnTime (i.e., the day on which OffTimes do not wrap all OnTimes). If it is a bizday, it counts ++ and then if it equals n return first set of dtStart and dtEnd. If not, the process begins again at the point of finding the next calendar day. If during the algorithm it is determined the calendar is not valid an error code is generated and results in “ErrorObject”

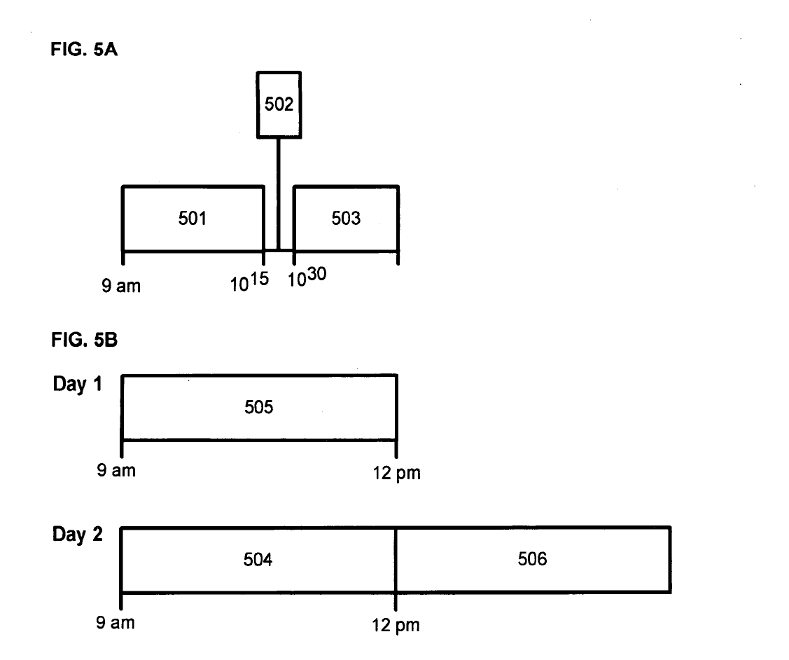

Finally, FIG. 5a illustrates the ability for the calendar to alert a user of an upcoming deadline or meeting at a predetermined number of days, hours or minutes before the event. For example, an event is scheduled 503 to occur at 10:30 am. However, the employee is in a meeting 501 from 9:00 am to 10:15 am. The meeting is running late. An alert 502 is sent to the employee, reminding he/she of the 10:30 am event.

FIG. 5b illustrates the ability to escalate the importance of an event at a predetermined number of days, hours or minutes after the event. For example, an assignment 506 is due by 12 noon on a particular day. However, the client has requested this assignment be completed 504 by 9:00 am on that same day. The user can escalate 505 the importance of this assignment some time in advance (days, hours, minutes), so that the employee will be provided ample time to complete the assignment in accordance with the desires of the client.

The advantage of this method is that a scheduler can use the information provided in the calendar, which identifies individual's availability to properly organize meetings and tasks, limiting the potential for time conflicts.

1. A method for business calendar event modeling implemented in computer instructions executed by a computer processor, comprising:
receiving a plurality of events from a computerized calendar user wherein each event is classified as an on time, off time or other time event and wherein:
the on time event defines a calendar period when the calendar user is available;
the off time event defines a calendar period when the calendar user is unavailable; and
the other time event defines a calendar period unrelated to the calendar user's availability;
calculating the calendar user's net on time, wherein the net on time is a sum of periods of a day wherein an on time event period does not overlap with an off time event period;
calculating user available days wherein a user available day is any day having net on time;
calculating number of user available days, hours and minutes before an event of the plurality of events; and
alerting a user to an event of the plurality of events at a predetermined number of days, hours or minutes before the event; or escalating an incomplete event of the plurality of events at a predetermined number of days, hours or minutes after the event.
